(19) United States
(12) Patent Application Publication
(10) Pub. No.: US 2007/0017097 A1
(43) Pub. Date: Jan. 25, 2007

(54) Combination razor and shaving cream dispenser

(76) Inventor: Christian T. Scheindel, Randolph Center, VT (US)

Correspondence Address: REED SMITH, LLP;ATTN: PATENT RECORDS DEPARTMENT, 599 LEXINGTON AVENUE, 29TH FLOOR, NEW YORK, NY, 10022-7650, US

(21) Appl. No.: 11/185,356

(22) Filed: Jul. 20, 2005

(51) Int. Cl. B26B 19/44

(52) U.S. Cl. 30/41

(57) ABSTRACT

A razor has a hollow handle in which a pressurized dispensing container is mounted to dispense shaving cream. The valve end of the container is positioned at the lower end of the handle so that gravity feed is employed to provide shaving cream at the valve. The dispensing valve is in communication with a dispensing opening at the end of the handle. The valve is spring loaded into a normally closed state. An opening at the upper end of the handle lets the user apply a finger to the base of the dispenser to push the dispenser down. When pushed down, the valve stem abuts against a rim at the dispensing opening of the razor thereby moving the valve into its open state. Shaving cream is thus dispensed through the bore of the valve stem and the dispensing opening at the end of the handle.

### BACKGROUND OF THE INVENTION

This invention relates to a pressurized shaving cream dispenser and a razor combined to provide a minimum cost, easy to handle product.

It is known to combine a razor with a shaving cream dispenser as shown in U.S. Pat. No. 5,070,611 dated Dec. 10, 1991, U.S. Pat. No. 4,791,723 dated Dec. 20, 1988 and U.S. Pat. No. 4,443,483 dated Feb. 28, 1984. For the convenience of the user, it is desirable to provide such a combination that facilitates single handed use when dispensing shaving cream.

Thus, it is one object of this invention to provide a device in which shaving cream can be dispensed using one hand.

It is also desirable to provide such a device in as simple a structure as possible, employing few parts, so as to provide a minimum cost combination device that will facilitate widespread use.

Accordingly, it is an object of this invention to provide such a combination with as few parts as possible so as to reduce the cost of materials and, more importantly, reduce the cost of assembly.

It is a related purpose of this invention to provide the above features in a device where accidental dispensing of shaving cream is minimized.

A further object of this invention is to provide these features in a design which permits ready replacement of the pressurized shaving cream dispensing container.

### BRIEF DESCRIPTION

In brief, the device of this invention employs a tubular pressurized shaving dispensing container mounted within the handle of the shaver. The container is mounted in a fashion that might be called upside down. That is, the dispensing nozzle of the pressurized container is located at the rear or bottom of the razor handle and the back surface of the pressurized container is located at a forward portion of the handle, close to but somewhat down from the shaving head.

An opening is provided near the top of the handle at the base of the pressurized container to permit the user's fingers to access the base. The dispensing valve of the container is positioned at the bottom of the handle and is in communication with a dispensing opening through the bottom of the handle.

The pressurized container is mounted within the handle for slidable axial movement within the handle. When the user presses a thumb or other finger on the base of the pressurized container and presses down, that will force the forward edge of the valve in the container against the rear base in the handle. This will cause the valve to open and dispense shaving cream. The bore of the valve stem is in registry with the dispensing opening in the back of the handle so that the dispensed shaving cream will flow through the valve bore and dispensing opening.

When the user's finger is removed from the base of the container, the normal spring loading of the valve to the off state will cause the pressurized container to move up sufficiently so that the valve will close and dispensing will stop.

### BRIEF DESCRIPTION OF THE DRAWINGS

FIG. 1 is an elevation view of the back of the razor handle partially broken away to illustrate the pressurized container 10 mounted within the handle 14 of the razor 12.

FIG. 2 is a side view of the FIG. 1 device.

FIG. 3 is a view similar to that of FIG. 1 on a larger scale illustrating a sealing ring 34 and stabilizing bumps 36.

FIG. 4 is a cross-sectional view through the three stabilizing bumps 36.

FIG. 5 is a longitudinal section through the dispensing valve 18.

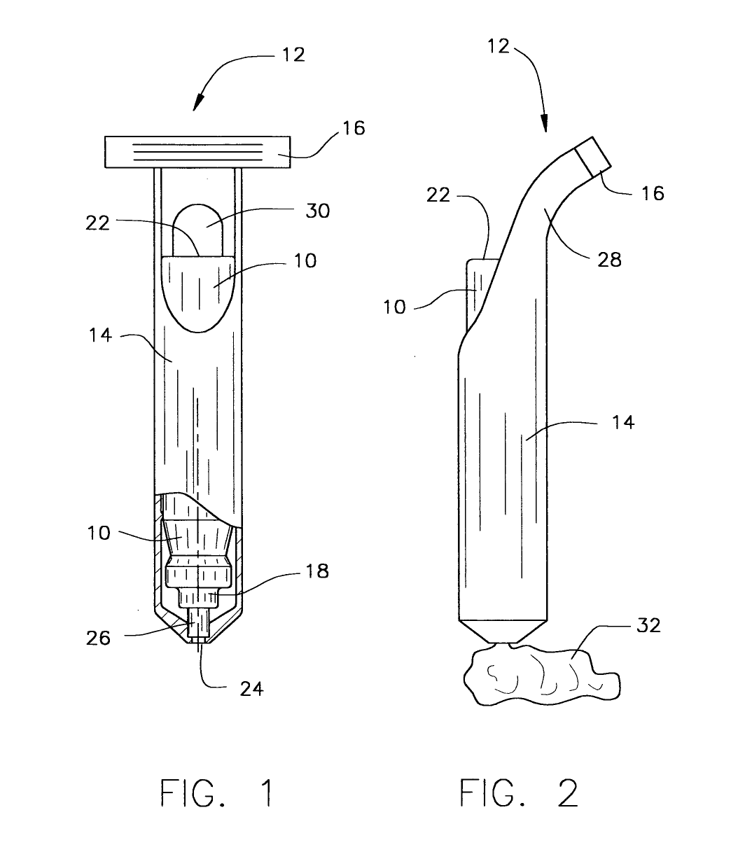

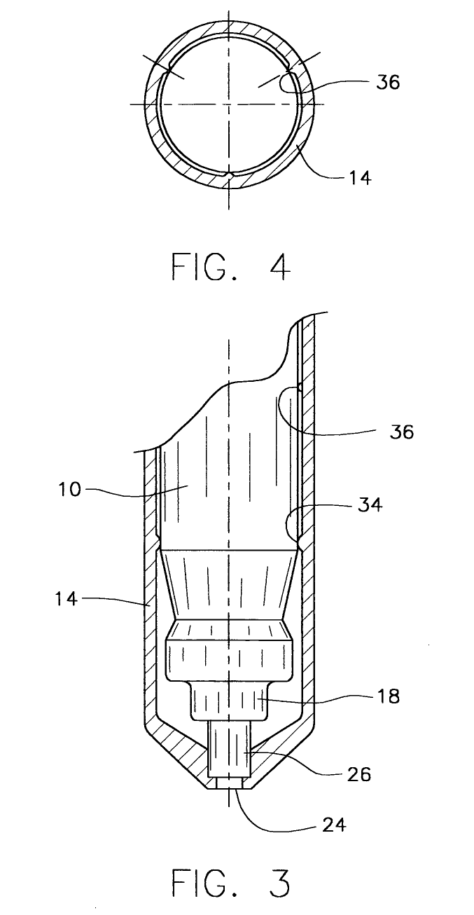

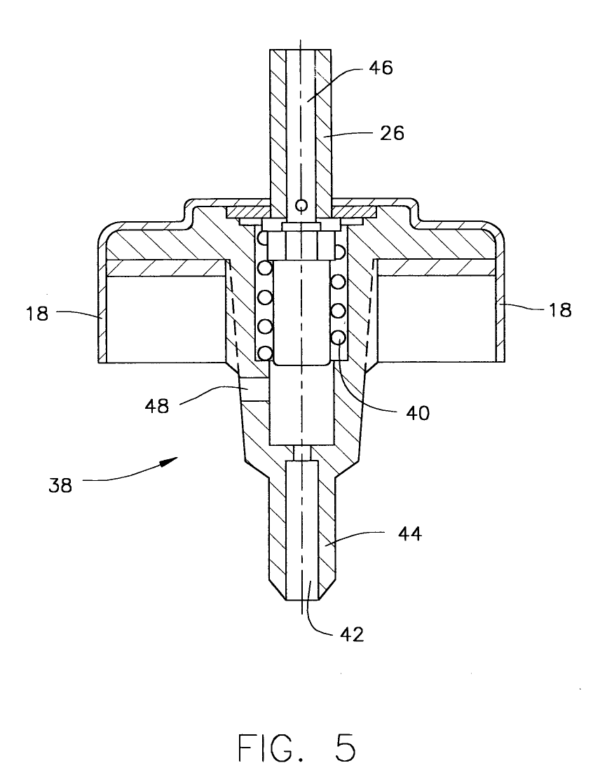

### BRIEF DESCRIPTION OF THE PREFERRED EMBODIMENTS

All of the FIGS. show a single embodiment.

A pressurized shaving cream dispenser 10 is mounted for sliding movement within the handle 14 of a razor 12. The dispenser 10 is mounted in an upside down fashion so that the shaving end 16 is at one end of the combination and the dispensing valve 18 of the pressurized dispensing container is at the other end of the combination.

The dispending container 10 is mounted for axial movement within the handle 14 of the razor 12. The back of the neck 28 near the upper portion of the razor handle 14 is cut away to permit manual access to the base 22 of the dispensing container 10.

A small opening 24 at the lower end of the handle 14 is sized to engage the wall of the valve stem 26 so that there is communication between the bore 46 of the valve stem 26 and the dispensing opening 24. When a user pushes down on the base 22 of the pressurized dispenser 10, the valve stem 26, which is resting on the edge of the opening 24, is depressed, thereby opening the valve and causing shaving cream product 32 to be dispensed through the bore 46 of the stem 26 and opening 24 of the handle 14.

When this manual pressure is released, the spring 40 (see FIG. 5) that is within the valve 18 returns the valve to its normally closed state. The pressurized dispenser 10 thereafter simply rests on its valve stem 26 against the inside surface of the handle at the opening 24.

The cut away in the handle 14 and neck 28 which permits finger or thumb pressure against the back surface 22 of the container 10 is sized so that the pressurized dispenser 10 can be removed and replaced. This is possible because the neck 28 extends radially away from the axis of the handle 14 to support the razor head 16 at a convenient use location.

However, because the dispensing container 10 is not affected by storing or by laying down the device, there is minimum risk of the shaving cream being accidentally dispensed.

When shaving, the razor is employed in a normal fashion. When shaving cream is to be dispensed, the razor head 16 is turned away from the face and the user presses a finger against the base 22 moving the dispenser body down in a axial direction thereby forcing the valve stem 26 into a retracted open or dispensing position.

As may be noted, there are no parts or mechanisms that switch the combination between an enabled state and a disabled state. The combination is always in an enabled state so that pressure on the base of the container 10 will cause shaving cream 32 to be dispensed.

One result is that this makes it easier for the user. Another important result is that it means fewer parts and less assembly thereby reducing the cost of the device.

The dispensing container 10 preferably has no dip tube. Accordingly, the dispensing of shaving cream is made with the opening of the handle 14 and the valve 26 positioned so that the shaving cream will be gravity fed to the valve 18.

An opening 30 in the front face of the handle 14 permits the user to grab the container 10 so as to remove the container 10 and permit its replacement.

An annular sealing ring 34 is molded as part of the inner wall of the handle 14 to prevent water from running down into the area around the valve stem 26. In one embodiment, where the container 10 has an outside diameter of 628 mils, the sealing ring 34 has an inner diameter of 626 mils. This sealing ring 34 aids in holding the container in position.

A series of three stabilizing bumps 36 may also be molded into the inner wall of the handle 14 at approximately the location shown. These stabilizing bumps 36 compensate for the taper that occurs along the inner wall of the molded handle 14 and assures that the container will not wobble.

To further assure against accidental removal and against wobbling of the container 10, there is a snug fit between the valve stem 26 and the opening of the handle which accommodates or accepts the valve stem. In one embodiment, where the valve stem is 109 mils, the housing opening that accepts the valve stem is 108 mils.

A standard valve 38, with one modification, is employed with the dispenser 10. To facilitate understanding of how this invention operates, FIG. 5 illustrates such a standard valve 38. In FIG. 5, the stem 26 is spring loaded by a spring 40 into a normally closed state. In operation, the shaving cream flows through the opening 42 at the tail 44 of the rear of the valve stem. When the valve is opened, shaving cream under pressure is forced through the tail opening 42, through the valve interior into the bore 46 of the valve stem 26 and out the dispensing opening 24. When the shaving cream level drops below the top end of the tail 44, no more shaving cream can be dispensed through the opening 42. However, one modified feature of the valve 38 is sidewall opening 48 in the valve that permits shaving cream to flow into the valve center until the shaving cream reaches the level of the opening 48. Thus, much less shaving cream is wasted.

While the foregoing description and drawings represent the presently preferred embodiments of the invention, it should be understood that those skilled in the art will be able to make changes and modifications to those embodiments without departing from the teachings of the invention and the scope of the claims.

What is claimed is:

1. A combination device comprising:
a razor having a shaving head and a tubular handle connected by a neck,
a pressured dispensing container mounted for axial movement within said handle,
said container having a base at a back end and a dispensing valve at a forward end,
a dispensing opening at the lower end of said handle,
said dispensing valve of said container being in communication with said dispensing opening of said handle,
an axial force at said base of said container moving said valve into engagement with a surface of said handle to force said valve into a dispensing state, whereby product will be dispensed through said dispensing valve and said dispensing opening.

2. The device of claim 1 wherein: said handle has a back opening through which a finger of a user can access said base forcing said container to move in an axial direction.

3. The device of claim 2 wherein: said back opening is sized to permit removal and replacement of said dispensing container.

4. The device of claim 1 further comprising: an opening in the neck of said handle to aid manual removal and replacement of said dispensing container.

5. The device of claim 1 wherein: said handle has an inner wall and a sealing ring along said inner wall to engage the dispensing container and prevent water passing below said sealing ring.

6. The device of claim 1 wherein: said handle has a tapered inner wall and a plurality of bumps along said inner wall at a position to stabilize said dispensing container within said tapered inner wall.

7. The dispensing container of claim 1 wherein: said handle has an annular surface adjacent to said dispensing opening sized to engage said stem of said valve to hold said stem in position.
